(19) United States
(12) Patent Application Publication
(10) Pub. No.: US 2003/0122367 A1
(43) Pub. Date: Jul. 3, 2003

(54) Golf scorecard and yardage system

(76) Inventor: Gary Wayne Reis, Oak Park, CA (US)

Correspondence Address: MICHAEL BLAINE BROOKS, A PROFESSIONAL CORPORATION, 5010 NO. PARKWAY CALABASAS, SUITE 104, CALABASAS, CA, 91302-3913, US

(21) Appl. No.: 10/033,499

(22) Filed: Dec. 27, 2001

(51) Int. Cl. G09B 19/00

(52) U.S. Cl. 283/50

(57) ABSTRACT

Disclosed is a golf scorecard and golf playing booklet for assisting players in playing a round of golf at a golf course and keeping score. The invention comprises panels, created by folding required for easy storage, that contain according to the teaching of the present invention course information, graphical depictions of the holes of a golf course including particulars such as hazards and yardage markers, and spaces for information related to course play including golfer names, hole numbers, distances from tees to green, handicap for each hole, score for each hole for each player, and score totals for each player. Some of the particular features of the present invention include prominent and repeatedly viewable advertising panels and a removable insert further containing course information, local course rules, instructions for booklet use, and/or additional, repeatedly viewable advertising space.

### BACKGROUND-DESCRIPTION OF THE PRIOR ART

Golf is a popular and growing sport with over 25 million golfers in the United States. Presently, U.S. golfers play at their choice of approximately 17,000 golf courses. Traditionally, the clubhouse of a golf course makes scorecards available to golfers before they begin playing a round of golf. Also available in some locations is a golf course yardage booklet that provides graphic illustrations, comments, and distances relating to each hole of the golf course. Some courses add cosmetic changes to their scorecards and presently provide small graphical representations of each hole either as part of one layout aerial view or as one of several individual views and in either case, the graphics lack distances and provide few details of the individual golf holes.

The traditional scorecards used in golf play are largely comprised of a sheet of cardstock folded once on what becomes a vertical fold line forming panels, or pages. In practice, one page is a front cover, one page is a back cover, while the two adjacent pages display the scoring grid and information relating to the golf round. Various golf scorecard and yardage book combinations have been introduced in the U.S. but their use has been extremely limited, almost to the point of no courses adopting their use. One patent, U.S. Pat. No. 5,284,340 to J. K. Laasko, describes a 10 or 11 page, accordion style folded booklet that will fit in a clothing pocket. Other scorecard and yardage booklet combinations consist of multiple pages of golf course hole graphics that are bound on a common edge by stitching, staples or wire binding as in U.S. Pat. No. 5,094,451 to M. G. Glamack and U.S. Pat. No. 4,331,425 to J. W. Davis. Similar prior art has been disclosed in U.S. Pat. No. 3,805,411 to Andrews, U.S. Pat. No. 6,027,417 to Zoretic, et al. and U.S. Pat. No. 5,023,070 to Maude. Other art shows variations of scoring systems to enhance keeping track of information used for gambling purposes between golfers. Little space is provided for scoring in these booklets. The above-mentioned prior art is generally expensive to produce, unwieldy to use, far from being traditional in look and use, and accordingly it is exceedingly rare to find the prior art being adopted for golf course use. The result is that golf courses have stayed with the more traditional look scorecards while trying to enhance them by additions to their design. One example of this design change is where very small golf hole graphics are added at various places on the card with no increase in size of the card itself. Further, scorecard booklets are generally only utilized by one score keeper for the round and then discarded after playing a round. The other members of the golfing group, normally groups of four, get one chance to see their score and then all evidence of the round disappears leaving little memory of the round to each golfer. With the number of different courses and rounds played each year by a normal golfer, there often is almost no conscious memory of a round except for a few specific shots and possibly a general memory of the number of strokes generally taken.

### SUMMARY

The present invention is a golf scorecard and golf playing booklet for assisting players in playing a round of golf at a golf course and scorekeeping, comprising a rectangular sheet of foldable material, folded into a highly portable booklet of panels that contain in whole or in part course information, graphical depictions of the holes of a golf course accompanied by yardage markers from tee and to pin, information regarding course play including golfer names, hole numbers, distances from tees to green, handicap for each hole, space for recording a score for each hole for each player, and spaces for recording score totals for each player, with one or more panels reserved for advertising or other information. The present invention includes an insert for instructions regarding use of the booklet and course play that may be withdrawn and reinserted by the user.

Objects and Advantages

Objects of the present invention include providing a relatively inexpensive, golf scorecard and golf playing booklet useful for those golfers seeking graphic assistance before their strokes and a graphical recordation system after each stroke and providing a combination of the look and utilitarian aspect of a traditional golf scorecard and yardage cards while showing hole characteristics in specificity such as hazards and yardage markers. A further object is to provide a means of recording a round of golf that will be informative and enhance the recollective memory of: the holes themselves, the shots played and the personal score of each golfer. Another object of the present invention is to provide space for informational or promotional content for use by the course and/or advertisers. The importance of this aspect of the booklet is that the information/promotional space is repeatedly viewed by the golfers while the round of golf is being played. The information provided is exposed multiple times to the golfers who are demographically desirable for marketing of the services of the golf course and also commercial or governmental advertisers. Another object of the present invention is to provide a medium so that an additional piece of paper can be loosely inserted in the folded booklet. One side of the sheet of paper contains information on use of the booklet, suggestions on how to keep personal stroke and shot statistics, and rules and course-oriented information. The second side of the sheet of paper inserted for the golfer's use is a customizable space for the course to use for example in promoting golf services and listing tournaments. The production of this insert is flexible enough that it can be updated at periods of golf course desire enabling customized marketing to the golfers.

### DESCRIPTION OF THE DRAWINGS

FIG. 1 is a view of the top side of the preferred embodiment of the booklet in its expanded format.

FIG. 2 is a view of the reverse side of the booklet.

FIG. 3 is a view of the booklet with a parallel fold having been made.

FIG. 4 is a view of the booklet with a second parallel fold having been made.

FIG. 5 is a view of the final compact form of the booklet

FIG. 6 is a view of the top side of the expanded booklet with the hole graphics in an alternative horizontal layout.

FIG. 7 is a view of the reverse side of the booklet's alternative hole graphics layout.

FIG. 8 is a view of the top side of the expanded form of the booklet showing an alternative orientation of the preferred embodiment.

FIG. 9 is a view of the reverse side of the expanded form of the booklet showing an alternative orientation of the preferred embodiment.

FIG. 10 is a view of the booklet after a horizontal fold has been made.

FIG. 11 is a view of the compact form of the secondary embodiment of the booklet where two folds have been made.

FIG. 12 is a view of an alternate arrangement of the secondary embodiment of the booklet with the golf hole graphics laid out in a horizontal format.

FIG. 13 is a view of an example of one of the graphical designs the elements of which are varied to adequately represent each hole of the booklet.

FIG. 14 is a view of a paper insert to be placed inside a pocket formed in the booklet of the preferred embodiment.

FIG. 15 is an example of graphical representation of one of the content and layout combinations of one side of the insert of the booklet.

### DETAILED DESCRIPTION OF THE INVENTION

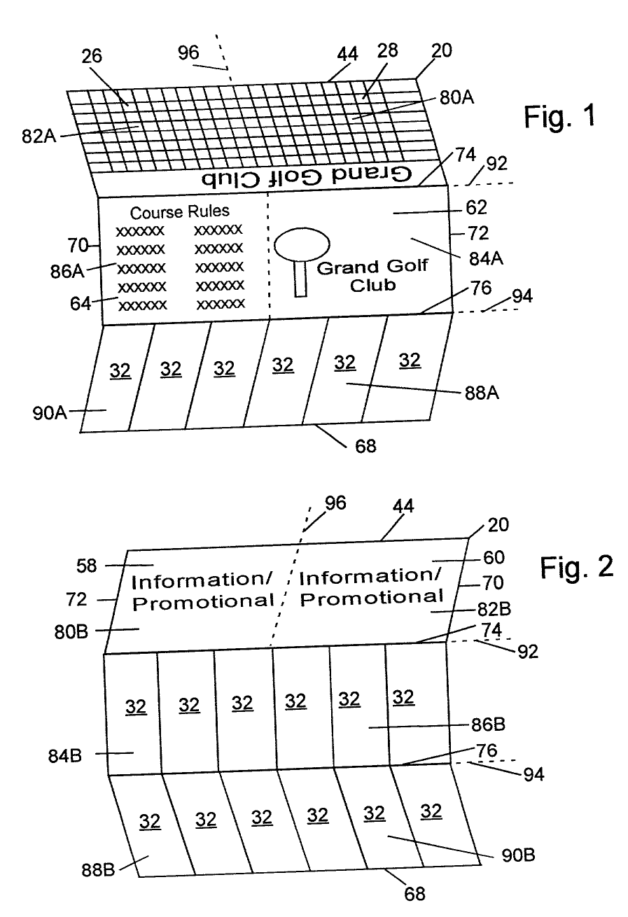

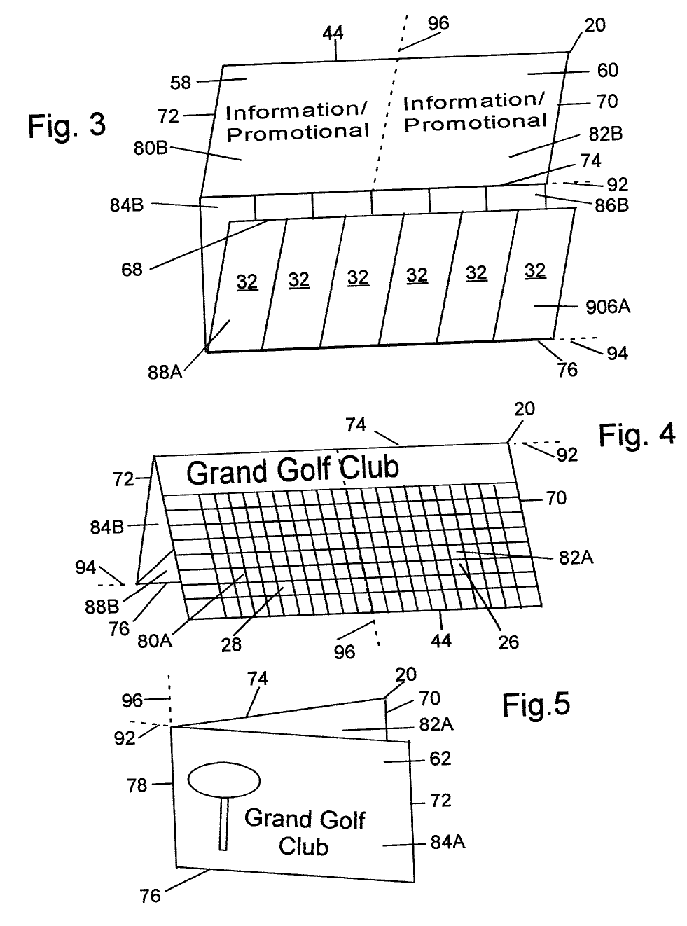

FIGS. 1, 2, 3, 4 and 5 illustrate the preferred embodiment of a golf scorecard and golf-playing booklet 20. FIGS. 1 and 2 are the opposite sides of the booklet 20 in an expanded form. FIGS. 3 and 4 show intermediate steps in the folding of the expanded form of booklet 20 resulting in the final compact form of the booklet 20 as shown in FIG. 5. The booklet 20 comprises a single sheet of paper or card stock where the preferred embodiment has two approximately parallel fold lines, an upper fold line 92 and a lower fold line 94. FIGS. 3 and 4 show the booklet 20 after parallel folds have been made. FIG. 5 shows the booklet 20 folded on fold line 96 that is perpendicular to the upper fold line 92 and the lower fold line 94. After the three folds have been made, six panels, each with two sides are formed.

FIG. 1 illustrates six panels on the top side of the expanded form of the booklet 20 and are: left upper panel 82A, right upper panel 80A, left middle panel 86A, right middle panel 84A, left lower panel 90A, and right lower panel 88A.

The back cover 64 is located on left middle panel 86A of FIG. 1. The back cover 64 of the booklet 20 contains local rules and regulations, course information such as address and phone numbers, and/or an aerial depiction view of the golf course showing the relationships of holes to each other. The aerial view on the back cover 64 also contains course identifying features such as the clubhouse, driving range, and parking lots.

FIG. 1 illustrates a partial scorecard 26 positioned on left upper panel 82A and a partial scorecard 28 positioned on right upper panel 80A. The partial scorecard 28 contains scores, ratings and handicaps for holes 1 through 9. The partial scorecard 26 contains scores, ratings and handicaps for holes 10 through 18. The partial scorecard 26 and the second partial scorecard 28 are in a inverted fashion (i.e., with the bottom of the graphics toward first edge 44). This print orientation allows the graphic to be viewed correctly as shown in FIG. 4.

FIG. 1 also illustrates the left lower panel 90A and the right lower panel 88A together containing graphic depictions of six holes of the golf course. The left lower panel 90A depicts holes 4 through 6 and the right lower panel 88A depicts holes 1 through 3. These two panels contain hole graphics with a print orientation such that the bottom is along the lower horizontal edge 76. This print orientation of holes 1 through 6 allows the hole graphics to be viewed correctly when the booklet 20 is viewed as in the form of FIG. 3.

FIG. 2 illustrates the six panels of the opposite side of the expanded form of booklet 20 and are: left upper panel 80B, right upper panel 82B, left middle panel 84B, right middle panel 86B, left lower panel 88B, and right lower panel 90B. The booklet 20 as shown in FIG. 2 is ready to be used to assist the play of golf on holes 7 through 18.

FIG. 2 further illustrates a space 58 located on the left upper panel 80B that contains specific information, promotional information, and/or advertising of local, regional or national entities. A second space 60 located on the right upper panel 82B contains specific information, promotional information, and/or advertising by local, regional or national entities.

FIG. 2 also illustrates the left middle panel 84B and the right middle panel 86B. These two panels contain depictions of a grouping of golf course holes 7 through 12. The left lower panel 88B and the right lower panel 90B contain depictions of a grouping of golf course holes 13 through 18.

FIG. 3 illustrates a step in the process of forming the compact form of booklet 20. The lower two panels of booklet 20 are folded at lower fold line 94 so that second edge 68 becomes adjacent to upper fold line 92 and the left lower panel 88B faces the left middle panel 84B and the right lower panel 90B faces the right middle panel 86B. This folding on lower fold line 94 forms an edge 76. In the format of FIG. 3 the booklet 20 is ready to be used to assist the play of golf on holes 1 through 6.

FIG. 4 illustrates the second step in the process of forming the compact form of booklet 20. The upper two panels of booklet 20 are folded at fold line 92 so that edge 44 becomes adjacent to edge 76 and the left upper panel 80B (not shown) faces the left lower panel 88A (not shown) and the right upper panel 82B (not shown) faces the right lower panel 90A (not shown). This folding of the booklet 20 on fold line 92 also forms upper horizontal edge 74. This form of the booklet 20 is used to score the round of golf using the scorecard now in view.

FIG. 5 illustrates the final compact form of the preferred embodiment of booklet 20. The booklet 20 of FIG. 4 is folded at the vertical fold line 96 so third edge 72 lies adjacent to fourth edge 70 and the right upper panel 80A (not shown) and left upper panel 82A face each other. The fold on the vertical fold line 96 forms a spine edge 78 perpendicular to the parallel horizontal edges of booklet 20 (i.e, upper horizontal edge 74 and lower horizontal edge 76). The compact form of the booklet 20, as shown in FIG. 5, can be carried in the pocket of an article of clothing.

FIG. 5 also shows that the front cover 62 of the booklet 20 can contain the golf course name, a logo or picture related to the course, and/or other desired course information. The front cover 62 is located on right middle panel 84A of FIG. 1.

Alternative Arrangement of Graphics of Preferred Embodiment

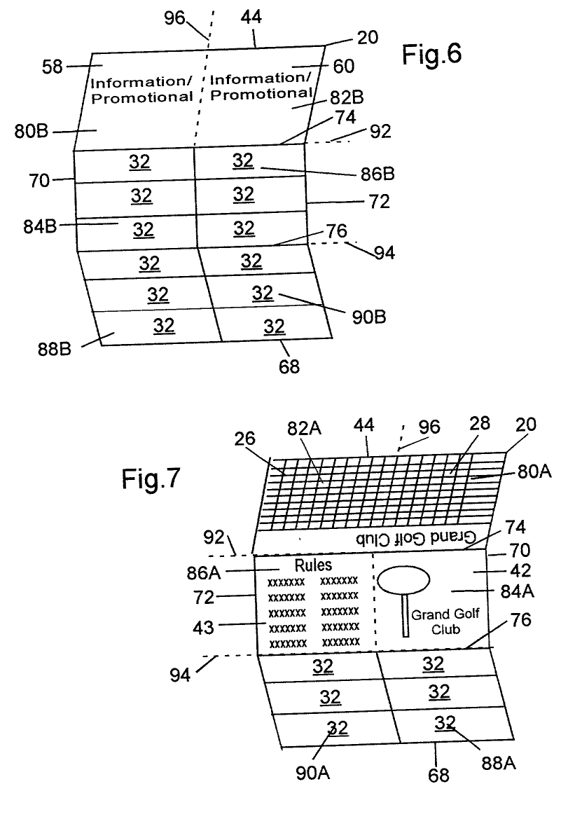

FIGS. 6 and 7 illustrate an alternate arrangement of the graphic depictions of the golf holes shown on the preferred embodiment of the booklet 20.

FIG. 6 illustrates the graphics depicting the golf course holes grouped horizontally. Holes 7 through 9 are depicted on the left middle panel 84B and holes 10 through 12 on the right middle panel 86B. The left lower panel 88B contains holes 13 through 15 and the right lower panel 90B contains holes 16 through 18.

FIG. 7 illustrates the reverse side of the alternative arrangement of the preferred embodiment as shown in FIG. 6 where now the left lower panel 90A contains holes 4 through 6 and the right lower panel 88A contains holes 1 through 3 and the hole graphics are positioned horizontally.

Alternate Embodiment of the Booklet

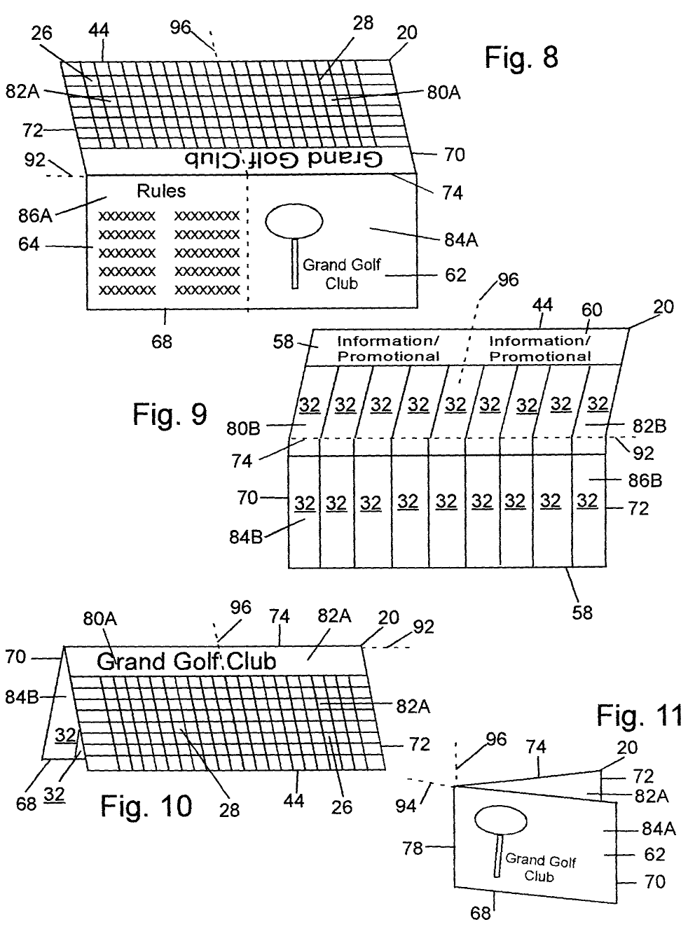

FIGS. 8, 9, 10 and 11 illustrate an alternate embodiment of booklet 20. FIGS. 8 and 9 are the opposite sides of the booklet 20 in its fully expanded form. FIGS. 10 and 11 show intermediate steps in the folding of the expanded booklet 20 resulting in the compact form of the booklet 20 as shown in FIG. 11. The booklet 20 comprises a single sheet selected from any thickness of commercially available paper or card stock.

FIG. 8 illustrates four panels on the top side of the fully expanded format of booklet 20 and are left upper panel 82A, right upper panel 80A, left lower panel 86A, and right lower panel 84A. The front cover 62 of the booklet 20 as shown in FIG. 8 contains the golf course name, a logo or picture related to the course, and/or other desired course information. The front cover 62 is located on the right lower panel 84A of FIG. 8. The back cover 64 of the booklet 20 contains local rules and regulations, course information such as address and phone numbers, and/or an aerial view perspective of the golf course showing the relationship of holes to each other, and course's distinctive features such as the clubhouse, driving range, and parking lots. The back cover 64 is located on the left lower panel 86A of FIG. 8.

FIG. 8 also illustrates one half of a score notation device 26 and a second half of a score notation device 28. The score notation device 28 placed on the right upper panel 80A relates to holes 1-9. The score notation device 26 placed on the left upper panel 82A relates to holes 10-18. The scorecard of the booklet 20 is laid out with the bottom of the graphics towards edge 44. This print orientation allows the graphic to be viewed correctly as shown in FIG. 10.

FIG. 9 illustrates the panels of the opposite side of the fully expanded format of the booklet 20 as shown in FIG. 8 where now there are a left upper panel 80B, a right upper panel 82B, a left lower panel 84B, and a right lower panel 86B. In this form the booklet 20 may be used to assist in the play of golf on holes 1 through 18. FIG. 9 illustrates a first promotional space 58 located on left upper panel 80B containing specific information, promotional information, and/or advertising by commercial of governmental entities. Another space 60 located on right upper panel 82B may contain specific information, promotional information, and/or advertising by commercial or governmental entities.

FIG. 9 also illustrates the left upper panel 80B and the right upper panel 82B where these two panels contain depictions of a grouping of golf course holes 1 through 9.

In addition, FIG. 9 illustrates a left lower panel 84B and a right lower panel 86B. These two panels contain depictions of a grouping of golf course holes 10 through 18 reading from left to right.

FIG. 10 illustrates a step in the process of forming the compact form of the booklet 20 shown in FIG. 11. The lower two panels of the booklet 20 are folded at the foldline 92 so that the first edge 44 becomes adjacent to the second edge 68 and the left lower panel 84B faces the left upper panel 80B and the right lower panel 86B faces the right upper panel 82B as these panels are shown in FIG. 9.

FIG. 11 illustrates the compact form of the alternate embodiment of the booklet 20. The booklet 20 is folded at fold line 96 so the edge 72 lies adjacent to the fourth edge 70 and the left upper panel 82A and faces the right upper panel 82A. The folding of FIG. 11 on the fold line 96 forms the spine edge 78.

Alternate Embodiment's Alternative Arrangement of Format

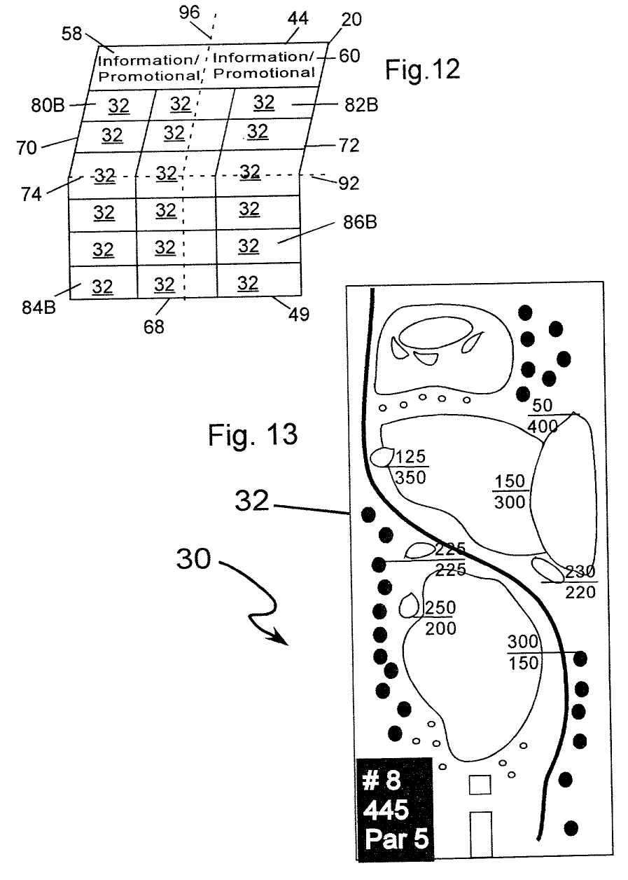

FIG. 12 illustrates one of a plurality of alternate layouts of the graphic depictions of the golf holes shown on the alternate embodiment of the booklet 20.

Graphic Representation of Holes

FIG. 13 illustrates one example 30 of a graphic representation 32 of a golf course hole layout including hole number, par for the hole, distance to the green, hazards, local properties (trees, water, etc.), and measured distances allowing variations that may show distance from the tee and/or distance to the green.

Insert For Booklet

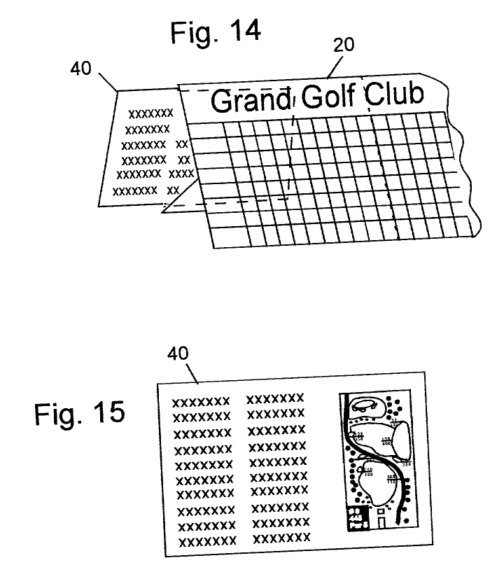

FIG. 14 illustrates an insert 40 that may be inserted into a fold of the booklet 20 in order to provide a additional information for the golfer in a format for ready reference.

FIG. 15 illustrates a rectangular sheet of variable thickness paper comprising an insert 40 for the booklet 20. This insert 40 preferably containing information related to the use of the booklet 20, and course and/or promotional information.

While certain exemplary embodiments have been described and shown in the accompanying drawings, it is to be understood that such embodiments are merely illustrative of and not restrictive on the broad invention. The scope of each claim term is not limited to the specific constructions and arrangements shown and described, since various other modifications may occur to those ordinarily skilled in the art.

Therefore, the invention has been disclosed by way of example and not limitation, and reference should be made to the following claims to determine the scope of the present invention.

I claim:

1. A golf scorecard and golf playing booklet for assisting players in playing a round of golf at a golf course and keeping score, said booklet comprising:
a rectangular sheet of foldable material having an upper side and a reverse side, said sheet having a plurality of substantially parallel primary folds thereby forming a series of panels foldably arranged one atop another;
one or more secondary folds in the sheet substantially perpendicular to the plurality of substantially parallel primary folds;
one or more panels further comprising a plurality of sub-panels formed by the one or more secondary folds providing at least two sub-panels foldably perpendicular to the primary folds, wherein:
one of the sub-panels forms a front cover of the booklet;
one of the sub-panels forms a rear cover of the booklet;
one or more of the sub-panels contains course information; and
a plurality of the sub-panels containing graphic depictions of the holes of a golf course wherein:
each of the plurality of panels with hole graphic depictions comprise a plurality of holes with a layout of sequential groupings;
a plurality of sub-panels comprise graphic depictions showing holes of a golf course in layout groupings; and
one or more of the sub-panels contain a golf score region with boxes for information related to course play comprising golfer names, hole numbers, distances from tees to green of each hole, handicap for each hole, score for each hole and score totals for each golfer.

2. The booklet of claim 1, wherein promotional, instructive and scorekeeping information is displayed on at least one surface of each panel.

3. The booklet of claim 2, wherein promotional, instructive and scorekeeping information is displayed on the upper side and reverse side of at least one panel.

4. The booklet as set forth in claim 2, wherein each depiction of an individual hole comprises a graphic depiction of the general layout of a golf hole of the golf course, sand traps, and other hazards where applicable to the golf hole, and yardage figures particular to such golf hole.

5. The booklet of claim 2 wherein the sheet of material is formed of paper of sufficient thickness and strength to be markable by pencil or pen.

6. The booklets of claim 2 wherein said booklet is insertable within clothing pockets three or more inches in width and three or more inches in depth.

7. The booklet of claim 2 with a sheet of paper inserted inside the folded form of the booklet said insert containing tailored promotional materials and information and instructions on use of the booklet.

8. The booklet of claim 2 wherein said plurality of substantially parallel primary folds are substantially evenly spaced.

9. A golf scorecard and golf playing booklet for assisting players in playing a golf course and keeping score, said booklet comprising:
a rectangular sheet of foldable material having an upper side and a reverse side, said sheet having a primary fold thereby forming a pair of panels that are foldably arranged one on top the other;
one or more secondary folds in the sheet substantially perpendicular to the primary fold; and
one or more panels further comprising a plurality of sub-panels, formed by the one or more secondary folds, providing a plurality of sub-panels foldably perpendicular to the primary folds, wherein:
one of the sub-panels forms a front cover of the booklet;
one of the sub-panels panels forms a rear cover of the booklet;
one or more of the sub-panels comprises, in part, course information or other information;
a plurality of the sub-panels containing graphic depictions of holes of a golf course wherein:
a plurality of sub-panels comprise graphic depictions showing holes of a golf course in layout groupings; and
one or more of the sub-panels contains a golf score region with boxes for information related to course play comprising golfer names, hole numbers, distances from tees to green of each hole, handicap for each hole, score for each hole and score totals for each golfer.

10. The booklet of claim 9, wherein promotional, instructive and scorekeeping information is displayed on at least one surface of each panel.

11. The booklet of claim 9, wherein promotional, instructive and scorekeeping information is displayed on the upper side and reverse side of one or more panels.

12. The booklet as set forth in claim 9, wherein each depiction of an individual hole comprises a graphic depiction of the general layout of a golf hole of the golf course, sand traps, and other hazards where applicable to the golf hole, and yardage figures particular to such golf hole.

13. The booklet of claim 9 wherein the sheet of material is formed of paper of sufficient thickness and strength to be markable by pencil or pen.

14. The booklet of claim 9 wherein said booklet is insertable within clothing pockets three or more inches in width and three or more inches in depth.

15. The booklet of claim 9 where a sheet of paper inserted inside the folded form of the booklet contains information and instructions pertaining to use of the booklet and space for golf course information or advertising or other promotional materials.

16. The booklet of claim 9 wherein said plurality of substantially parallel primary folds are substantially evenly spaced.
